(19) United States
(12) Patent Application Publication
(10) Pub. No.: US 2013/0004324 A1
(43) Pub. Date: Jan. 3, 2013

(54) NANO-STRUCTURED FAN AIRFOIL SHEATH

(75) Inventors: James O. Hansen, Glastonbury, CT (US); Joseph Parkos, East Haddam, CT (US)

(73) Assignee: UNITED TECHNOLOGIES CORPORATION, Hartford, CT (US)

(21) Appl. No.: 13/173,816

(22) Filed: Jun. 30, 2011

(51) Int. Cl. F01D 5/14; C25D 15/00; B82Y 99/00

(52) U.S. Cl. 416/224; 205/109; 977/777

(57) ABSTRACT

A method of forming a sheath for a fan airfoil having a leading edge, a trailing edge, a tip, a root, a suction side and a pressure side includes electroplating a nano-structured material to form a sheath with a solid portion to wrap around the leading edge and first and second flanks to secure the solid portion to the pressure side and the suction side of the airfoil.

### BACKGROUND

When exposed to impact loading, for example, a bird strike, a blade is subject to cracking, delamination (if the blade is a composite laminate blade) and deformation. This cracking or delamination from an impact loading is usually initiated at the leading edge of an airfoil. The cracking and delamination can then spread to other sections of the blade, potentially resulting in catastrophic failure of the blade. Fan blades are also subject to significant rain and sand erosion, especially at the leading edge.

Adding a protective sheath over the leading edge of a lightweight airfoil, such as one made of aluminum alloy or a composite, can give the blade substantially all the strength of a blade made entirely of a high strength metal such as a titanium alloy. This strength helps to protect against cracking, delamination and deformation. Additionally, the leading edge can be made thinner than the lower strength or lower strain capable material it protects. Thinner leading edges provide engine efficiency improvements. A high strength metallic material offers significant benefits in weight and efficiency by restricting the use of the heavier, higher-strength material to only the sheath. The overall shape of a sheath and the need for a thin, sharp leading edge makes fan blade sheaths difficult and expensive to machine. Typically, sheaths for composite turbofan engine fan blades are made of titanium. Titanium is used for most legacy fan blades and has good strength and impact characteristics.

Electroformed sheaths have been used in certain propeller and helicopter blades to provide wear and erosion resistance. Propeller blades generally have large leading radii and blunt leading edges, making propeller blades able to resist cracking from impacts, leaving the sheath to resist erosion. However, the technology cannot be easily adapted to blades for use in a turbofan engine due to the need for sharp leading edges on thin blades, and the speed of foreign objects striking the blades. The electroformed sheaths for propeller blades, typically made by electroplating Nickel (“Ni”) or Nickel-cobalt (“Ni—Co”), do not have adequate strength and ductility, in thin sections to adequately protect a fan blade in a turboengine.

### SUMMARY

A method of forming a sheath for a fan airfoil having a leading edge, a trailing edge, a tip, a root, a suction side and a pressure side includes electroplating an ultra-fine grained or nano-structured material to form a sheath with a solid portion to wrap around the leading edge and first and second flanks to secure the solid portion to the pressure side and the suction side of the airfoil.

A sheath for a fan airfoil having a leading edge, a trailing edge, a tip, a root, a suction side and a pressure side includes a solid portion to wrap around the airfoil leading edge; a first flank for attaching the solid portion to the pressure side; and a second flank for attaching the solid portion to the suction side, wherein the sheath is electroformed with an ultra fine grained or nano-structured material.

### BRIEF DESCRIPTION OF THE DRAWINGS

FIG. 1 is a cross-sectional view of a gas turbine engine.

FIG. 2 is a perspective view of a composite blade with sheath according to the present invention.

FIG. 2A is a cross-sectional view of the composite blade with sheath of FIG. 2 from line A-A.

### DETAILED DESCRIPTION

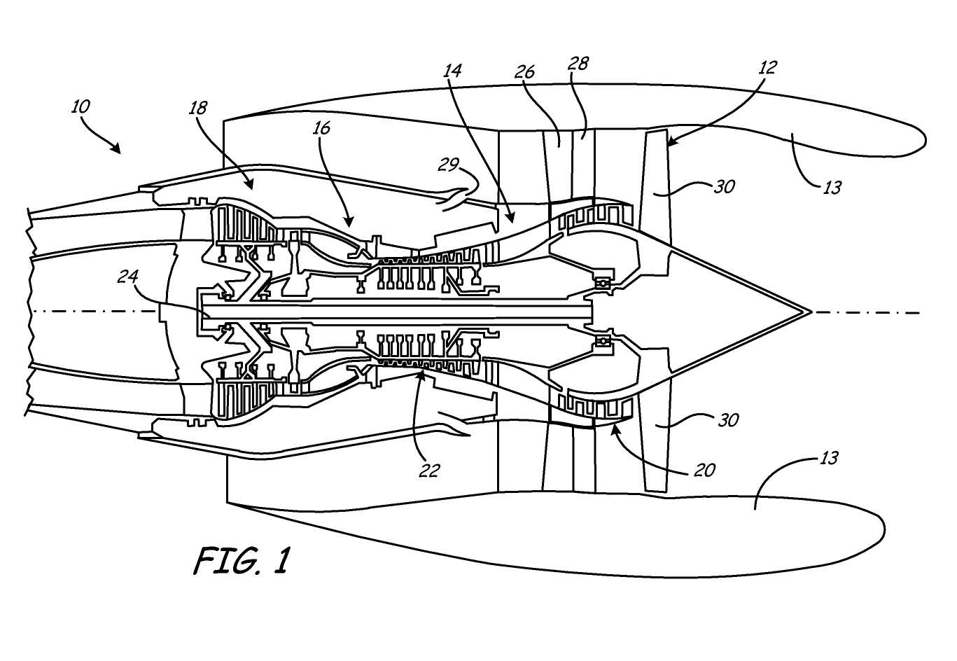

FIG. 1 is a cross-sectional view of gas turbine engine 10, which includes turbofan 12, fan case 13, compressor section 14, combustion section 16 and turbine section 18. Compressor section 14 includes low-pressure compressor 20 and high-pressure compressor 22. Air is taken in through fan 12 as fan 12 spins in fan case 13. A portion of the inlet air is directed to compressor section 14 where it is compressed by a series of rotating blades and vanes. The compressed air is mixed with fuel, and then ignited in combustor section 16. The combustion exhaust is directed to turbine section 18. Blades and vanes in turbine section 18 extract kinetic energy from the exhaust to turn shaft 24 and provide power output for engine 10.

The portion of inlet air which is taken in through fan 12 and not directed through compressor section 14 is bypass air. Bypass air is directed through bypass duct 26 by guide vanes 28. Some of the bypass air flows through opening 29 to cool combustor section 16, high pressure compressor 22 and turbine section 18. Fan 12 includes a plurality of blades 30 which spin in fan case 13.

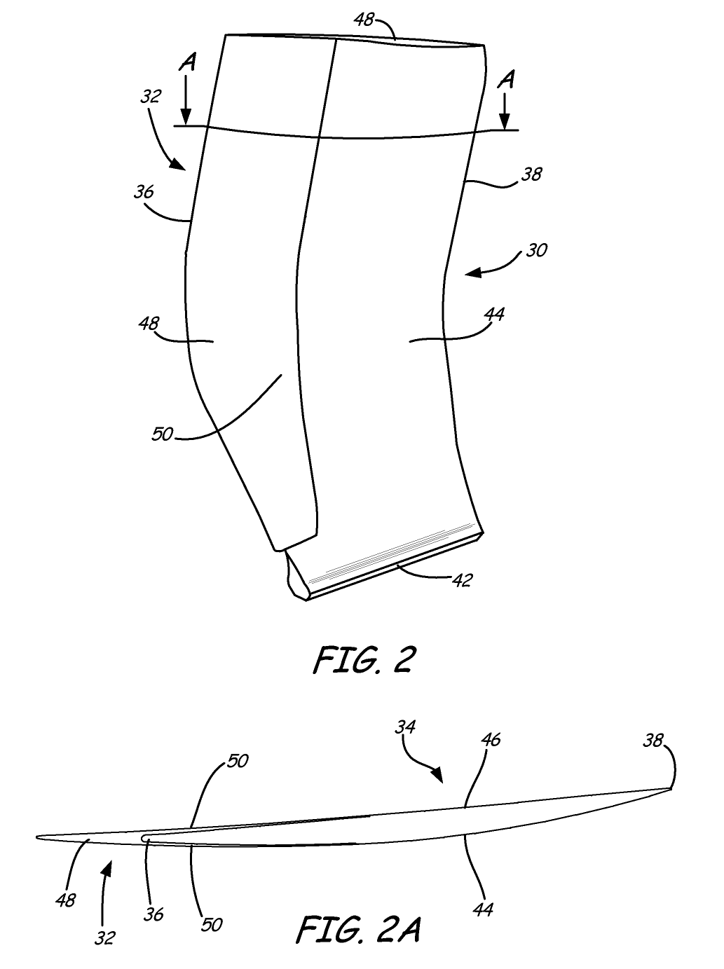

FIG. 2 illustrates blade 30 with electroformed nano-structure sheath 32. FIG. 2A illustrates a cross-sectional view of blade 30 with sheath 32 taken along line A-A in FIG. 2.

Blade 30 includes airfoil 34 with leading edge 36, trailing edge 38, tip 40, root 42, suction side 44 and pressure side 46. Sheath 32 includes solid portion 48 covering leading edge 36, and tapered flanks 50 extending from each side of solid portion 48. The cross-sectional view of blade 30 with sheath 32 in FIG. 2A includes sheath solid portion 48 with tapered flanks 50, and airfoil 34 with leading edge 36, trailing edge 38, suction side 44 and pressure side 46.

Sheath 32 covers leading edge 36 of airfoil 34 with solid portion 48 by bonding tapered flanks 50 to suction side 44 and pressure side 46 of airfoil 34. Tapered flanks 50 can be bonded to suction side 44 and pressure side 46 with various adhesives including, but not limited to, rubber, silicone or epoxy resin. Sheath 32 can be made of an ultra fine grained or nano-structured material, such as nano-Ni, nano-Co or a nano-Ni/Co alloy, which has sufficient stiffness and strength to withstand an impact load, such as a bird strike. The ultra fine grained or nano-structured material can have a grain size of about 10 nanometers to about 100 nanometers. Solid portion 48 of sheath 32 can vary in thickness to ensure that it covers the entire leading edge 36 of airfoil 34 and can be about 0.1 inches (2.54 mm) to about 0.2 inches (5.08 mm) thick. The length of solid portion 48 (extending out from leading edge 36) can vary widely, but must be sufficiently long to provide protection for leading edge 36 of blade 30.

Sheath 32 can be made by conventional electroplating of a nano-Ni material. This typically includes placing a tool formed corresponding to the desired sheath shape in a bath, hooking up a current to the tool, and allowing sufficient time for metal ions from the bath solution to plate directly onto the tool until the desired sheath thickness is reached. Once a desired thickness is reached, the tool is extracted from the bath, and the sheath is separated from the tool. The separation can be done by hand, by machine or a combination of both. The tool can then be reused. For a nano-Ni sheath, the tool can be made of titanium.

Past leading edge sheaths were generally made by machining a piece of titanium into a desired shape corresponding with the blade to which the sheath was to be bonded. This process was very difficult due to the shape of a blade and the sharp edges required on the leading edge. This machining process also resulted in wasted material. The process of machining a sheath generally took about 30 hours, making it costly in terms of manufacturing personnel as well. By electroforming the sheath, no metal waste is generated. Additionally, the electroforming results in a sheath that is generally more uniform in thickness and shape and requires fewer man-hours to make.

The use of nano-Ni in electroformed sheath 32 can increase the strength, toughness, hardness and ductility of sheath 32. This leads to improved bird strike and erosion capability over conventional electroplated Ni sheaths. The ultra fine grained size results in improved strength and ductility over conventional coarse grained materials. Past electroformed sheaths were generally formed of Ni or Ni—Co. Electrofomed Ni—Co has good strength properties (ultimate tensile strength “UTS” of about 225 ksi and yield strength “YS” of about 137 ksi), but low ductility, for example 3% elongation ductility. Ni plating generally has good ductility properties, but lower strength. The use of nano-Ni, nano-Co or nano-Ni/Co alloy in electroforming results in sheath 32 having good strength due to the fine grain size in the material (UTS of about 180 ksi and YS of about 120 ksi) and good ductility, for example 7% elongation ductility. The high strength helps to resist cracking and deformation after impacts, and the high ductility allows the sheath to tolerate additional deflection instead of simply cracking when subject to an impact.

Electroformed nano-Ni sheath 32 provides extra strength to blade 30, allowing blade 30 to be made of lightweight materials, such as composites or aluminum (including aluminum alloys), and still maintain optimal performance and levels of aerodynamic efficiency under impact loading similar to the levels of prior art metal blades. Solid portion 48 of sheath 32 provides a layer of protection against impacts and erosion for leading edge 36 of airfoil 34. Tapered flanks 50 bond solid portion 48 to airfoil to hold solid portion 48 in place. Tapered flanks 50 further provide extra stiffness to airfoil 48 and more surface area for a smooth load transfer during impacts to blade 30.

In summary, electroformed nano-structure sheath 32 provides strength, toughness, hardness and ductility to allow blade 30 to be made of lighter, more economical materials while maintaining similar resistance to erosion and impact cracking as past blades made of expensive material such as titanium. The use of electroplating makes the manufacture of sheath 32 more economical and more uniform than past methods of machining. The use of nano-structured materials, such as nano-Ni, allows for the use and benefits of electroforming while maintaining high levels of strength and ductility.

Sheath 32 can be used to protect against delamination, deformation and cracking in any type of light weight blade (composite, carbon fiber, aluminum, etc.). While the means of securing sheath 32 to blade 30 is discussed as tapered flanks 50, different means can be used to secure solid portion 48 of sheath 32 to airfoil 34.

While a general process was discussed in relation to electroforming sheath 32, this was for example purposes only and any electroforming process generally known in the art can be used to electroform nano-structured sheath 32. While the invention has been described mainly in relation to nano-Ni sheaths, sheath 32 can be formed of other ultra-fine grained materials.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. For example, sheath could be formed in a different shape such as extending over the tip of blade as well as the leading edge. Therefore, it is intended that the invention not be limited to the particular embodiment(s) disclosed, but that the invention will include all embodiments falling within the scope of the appended claims.

1. A method of forming a sheath for a fan airfoil having a leading edge, a trailing edge, a tip, a root, a suction side and a pressure side, the method comprising:
electroplating a nano-structured material to form a sheath with a solid portion to wrap around the leading edge and first and second flanks to secure the solid portion to the pressure side and the suction side of the airfoil.

2. The method of claim 1, wherein the nano-structured material is a nano-nickel material.

3. The method of claim 1, wherein the nano-structured material is a nano-cobalt material.

4. The method of claim 1, wherein the nano-structured material is a nano-nickel/cobalt alloy material.

5. The method of claim 1, wherein the sheath is formed to be attached to the leading edge of an aluminum alloy airfoil.

6. The method of claim 1, wherein the sheath is formed to be attached to the leading edge of a composite airfoil.

7. A sheath for a fan airfoil having a leading edge, a trailing edge, a tip, a root, a suction side and a pressure side, the sheath comprising:
a solid portion to wrap around the airfoil leading edge;
a first flank for attaching the solid portion to the pressure side; and
a second flank for attaching the solid portion to the suction side, wherein the sheath is electroformed with a nano-structured material.

8. The sheath of claim 7, wherein the nano-structured material is a nano-nickel material.

9. The sheath of claim 7, wherein the nano-structured material is a nano-cobalt material.

10. The sheath of claim 7, wherein the fan airfoil is made of an aluminum material.

11. The sheath of claim 7, wherein the fan airfoil is made of a composite material.

12. The sheath of claim 7, wherein the sheath is attached to the airfoil by bonding.

13. The sheath of claim 7, wherein the first flank and the second flank are tapered.

14. The sheath of claim 7, wherein the solid portion forms a sharp leading edge on the airfoil.

15. A blade with a sheath comprising:
a blade with a fan airfoil, a leading edge, trailing edge, root and tip; and
a sheath secured to the leading edge of the airfoil, wherein the sheath has been electroformed from a material with an ultra fine grain size.

16. The blade of claim 15, wherein the sheath comprises:
a solid portion to cover the leading edge;
a first flank to bond to the pressure side of the airfoil; and
a second flank to bond to the suction side of the airfoil.

17. The blade of claim 15, wherein the sheath is made of a nano-Ni material, nano-cobalt material, a nano-nickel alloy material or a nano-cobalt alloy material.

18. The blade of claim 15, wherein the blade is made of an aluminum material.

19. The blade of claim 15, wherein the sheath has a sharp leading edge.

20. The blade of claim 15, wherein the blade is made of a composite material.
